(19) United States
(12) Patent Application Publication
(10) Pub. No.: US 2026/0257490 A1
(43) Pub. Date: Sep. 3, 2026

(54) PRINTING APPARATUS, COLORIMETRIC METHOD, AND COMPUTER-READABLE NON-TRANSITORY RECORDING MEDIUM STORING PROGRAM

(71) Applicant: Konica Minolta, Inc., Tokyo (JP)

(72) Inventor: Shun HIGA, Tokyo (JP)

(21) Appl. No.: 19/549,582

(22) Filed: Feb. 25, 2026

(30) Foreign Application Priority Data
Feb. 28, 2025 (JP) 2025-031546

(51) Int. Cl. B41J 2/21; B41J 2/165; B41J 2/175; B41J 11/00

(52) U.S. Cl. CPC B41J 2/2103; B41J 2/16535; B41J 2/16579; B41J 2/17566; B41J 11/007

(57) ABSTRACT

A printing apparatus includes: a sheet feeder that feeds a recording material; a printer that forms an image based on a print job on the recording material to produce a printed material; a sheet ejection section to which the printed material is ejected; a conveyer that conveys the recording material and the printed material; and a hardware processor that controls an operation related to color measurement. The hardware processor causes a colorimetric printed material to be produced in a case where maintenance in which the print job is inexecutable is performed.

### CROSS REFERENCE TO RELATED APPLICATIONS

The entire disclosure of Japanese Patent Application No. 2025-031546 filed on February 28, 2025 is incorporated herein by reference in its entirety.

### BACKGROUND

### Technological Field

The present disclosure relates to a printing apparatus, a colorimetric method, and a program.

### Description of Related Art

In general, in a printing apparatus, color adjustment (color calibration) is periodically performed in order to maintain color reproducibility and produce a printed material with stable color quality. The color adjustment is performed, for example, on the basis of a color measurement result of a colorimetric chart by a colorimeter (color characteristics of a printing apparatus) (see, for example, Patent Literature (hereinafter, referred to as “PTL”) 1 (Japanese Unexamined Patent Publication No. 2015-211445)). PTL 1 discloses that in an electrophotographic printing apparatus, color measurement and color adjustment are performed during execution of a print job.

However, in order to perform accurate color measurement, it is necessary to perform color measurement after the color of the color material adhered to the recording material is stabilized. The time required for the color material to stabilize its color is, for example, several tens of minutes to several hours. In a case of performing color adjustment based on a color measurement result, since it is necessary to wait until color measurement is completed, productivity decreases.

### SUMMARY

Objectives of the present disclosure include providing a printing apparatus, a colorimetric method, and a computer-readable non-transitory recording medium storing a program that can reduce a standby time involved in color measurement and improve productivity.

In order to achieve at least one of the above-mentioned objectives, a printing apparatus reflecting one aspect of the present disclosure includes:

a sheet feeder that feeds a recording material;

a printer that forms an image based on a print job on the recording material to produce a printed material;

a sheet ejection section to which the printed material is ejected;

a conveyer that conveys the recording material and the printed material; and

a hardware processor that controls an operation related to color measurement, in which

the hardware processor causes a colorimetric printed material to be produced in a case where maintenance in which the print job is inexecutable is performed.

A colorimetric method reflecting one aspect of the present disclosure is a colorimetric method for a printing apparatus that forms an image based on a print job on a recording material to produce a printed material, the method including:

determining whether or not maintenance in which the print job is inexecutable is performed; and

producing a colorimetric printed material when the maintenance is performed.

A computer-readable non-transitory recording medium storing a program reflecting an aspect of the present disclosure is a non-transitory computer-readable recording medium storing a program that causes a computer of a printing apparatus to perform predetermined processing, the printing apparatus forming an image on a recording material based on a print job to produce a printed material, the predetermined processing including:

processing of determining whether or not maintenance in which the print job is inexecutable is performed; and

processing of producing a colorimetric printed material when the maintenance is performed.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an inkjet printing apparatus according to an embodiment of the present disclosure;

FIG. 2 is a diagram illustrating a main part of a control system of the inkjet printing apparatus 1; and

FIG. 3 is a flowchart illustrating an example of colorimetric processing.

### DETAILED DESCRIPTION OF EMBODIMENTS

Hereinafter, one or more embodiments of the present invention will be described with reference to the drawings. However, the scope of the invention is not limited to the disclosed embodiments.

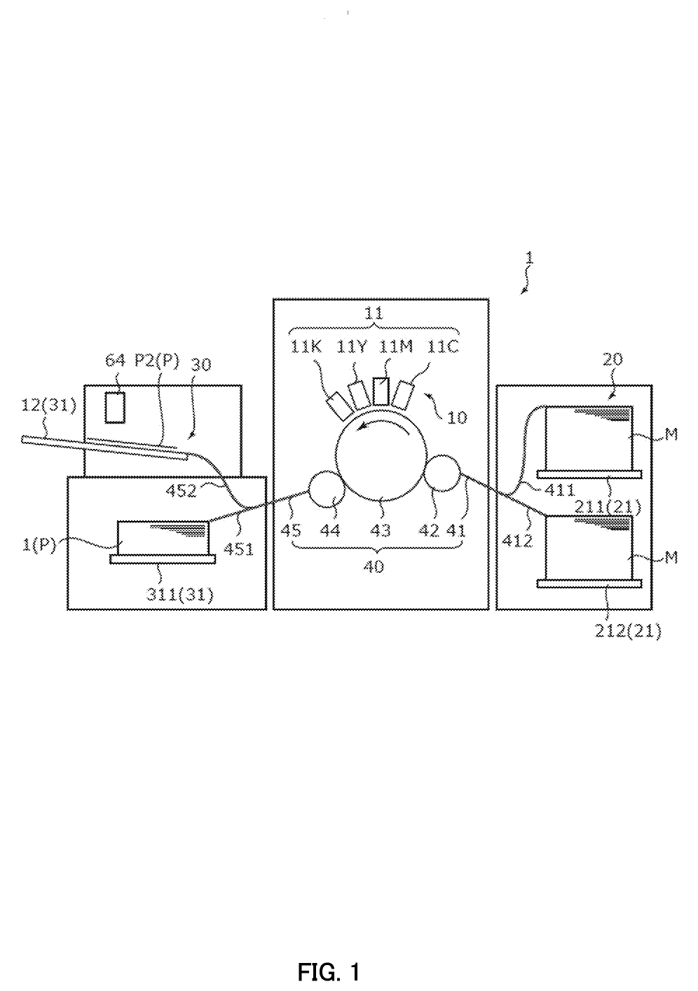

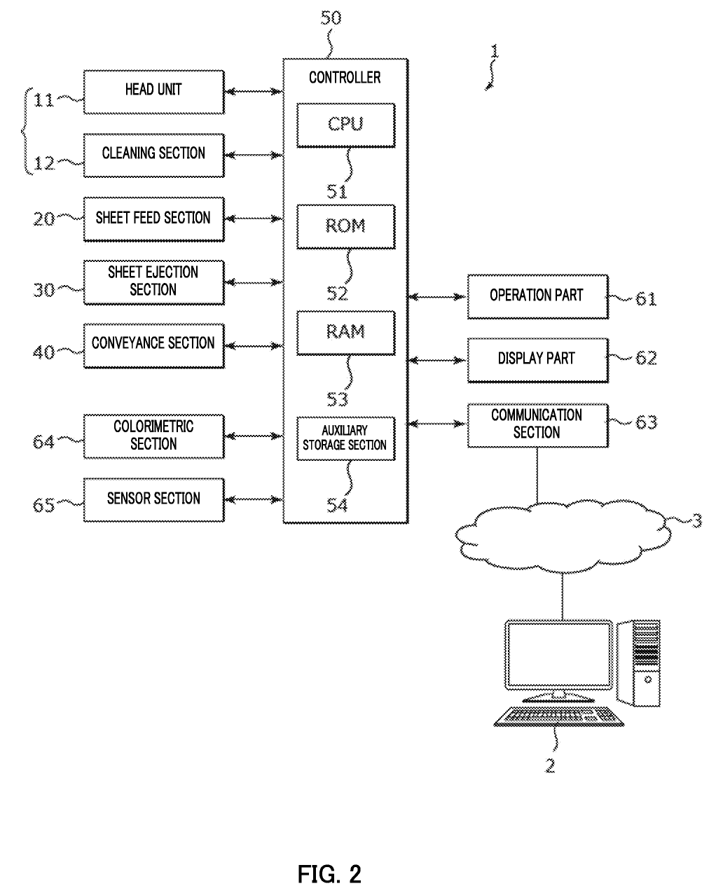

FIG. 1 is a view schematically illustrating an overall configuration of an inkjet printing apparatus 1 according to an embodiment of the present disclosure. FIG. 2 is a diagram illustrating a main part of a control system of the inkjet printing apparatus 1.

The inkjet printing apparatus 1 is a single-pass printing apparatus that forms an image by ejecting ink onto a recording material M conveyed along a predetermined conveyance direction. The inkjet printing apparatus 1 receives, for example, a print job transmitted from the terminal device 2 via the communication network 3, and performs printing based on the received print job.

Examples of the print job include various kinds of information about printing, such as document data, a page description language, setting of a recording material, print quality, a print layout, and the number of copies. The document data includes data of images, text, and graphics. The setting of the recording material includes setting of a size, a type (plain paper, glossy paper, coated paper, or the like), and an orientation (vertical/horizontal) of the recording material, a sheet feed tray, and a sheet ejection tray. The print quality includes resolution, a print mode (standard, high quality, photo, or the like), and the type of ink (color/monochrome).

As the recording material M, in addition to paper such as a plain paper or a coated paper, various media such as textiles or resin films can be used on which ink having landed on the surface can be fixed.

As illustrated in FIGS. 1 and 2, the inkjet printing apparatus 1 includes a printing section 10, a sheet feed section 20, a sheet ejection section 30, a conveyance section 40, a controller 50, an operation part 61, a display part 62, a communication section 63, a colorimetric section 64, and a sensor section 65.

The printing section 10 includes one or a plurality of head units 11. Each of the head units 11 is an ink jet head unit capable of ejecting a color ink. In the example illustrated in FIG. 1, four head units 11C, 11M, 11Y, and 11K corresponding to four colors of cyan (C), magenta (M), yellow (Y), and black (K) are disposed so as to be aligned at predetermined intervals in order from the upstream side in the rotation direction of the conveyance drum 43.

The head unit 11 has an ink ejection face that faces the conveyance surface of the conveyance drum 43. A large number of nozzles are formed on the ink ejection face. In addition, the head unit 11 includes a head drive section (for example, a piezoelectric element) which causes a predetermined amount of ink to be ejected from the nozzles at a predetermined timing. The operation of the head unit 11 is controlled by the controller 50.

The printing section 10 includes a cleaning section 12. The cleaning section 12 cleans the ink ejection face of the head unit 11. The cleaning section 12 cleans the head unit 11, for example, in automatic maintenance that is periodically performed. Further, for example, the cleaning section 12 may clean the head unit 11 based on a manual instruction from the operation part 61. Operation of the cleaning section 12 is controlled by the controller 50.

The cleaning section 12 includes a cleaning member that wipes liquid droplets remaining on the ink ejection face of the head unit 11. The cleaning member is, for example, a roll-shaped cleaning web formed of paper or cloth. The cleaning web is rewound while being fed little by little in accordance with rotation of the roller, and cleans the ejection face of the head unit 11 with a new surface. The used cleaning web is periodically replaced. Note that the cleaning member may be a member other than the cleaning web, such as a cleaning roller.

The printing section 10 may include a fixing section (not illustrated) for fixing ink onto the recording material M. The fixing section is disposed on the downstream side of the head unit 11 in the conveyance direction. The fixing section cures and fixes the ink to the recording material M, for example, by irradiating the ink with energy rays such as ultraviolet rays.

The printing section 10 forms an image on the recording material M based on a print job. A print job for generating the normal printed material P1 will be referred to as a "normal job", and a print job for generating the colorimetric printed material P2 will be referred to as a "colorimetric job". The image formed on the colorimetric printed material P2 is, for example, a colorimetric chart in which various color patches are arranged.

The sheet feed section 20 feeds the recording material M to the printing section 10 via the conveyance section 40. The sheet feed section 20 includes a sheet feed tray 21 that stores the recording material M. The number of the sheet feed trays 21 may be one or more. In the sheet feed tray 21, for example, sheets of paper (standard paper, special paper) identified based on the basis weight, size, and the like are stored for each paper type set in advance. The recording materials M stored in the plurality of sheet feed trays 21 may be the same or different. Information on the recording material M stored in the sheet feed tray 21 is stored in, for example, the ROM 52.

In the present embodiment, a first sheet feed tray 211 and a second sheet feed tray 212 are provided as the sheet feed trays 21. In a case where a plurality of sheet feed trays 21 are provided, when the recording material M stored in one sheet feed tray 21 is replenished/replaced, the recording material M can be fed from another sheet feed tray 21 to execute a print job.

The sheet ejection section 30 stores the printed material P conveyed from the printing section 10 via the conveyance section 40. The sheet ejection section 30 includes a sheet ejection tray 31 that stores the printed material P. The number of sheet ejection trays 31 may be one or more.

In the present exemplary embodiment, a first sheet ejection tray 311 and a second sheet ejection tray 312 are provided as the sheet ejection trays 31. The first sheet ejection tray 311 is used for sheet ejection of the normal printed material P1. The second sheet ejection tray 312 is used for ejecting the colorimetric printed material P2. The second sheet ejection tray 312 may be used to eject the normal printed material P1, for example, when a conveyance failure occurs in the first sheet ejection path section 451.

When a plurality of sheet ejection trays 31 are provided, one sheet ejection tray 31 can be used for ejecting the normal printed material P1 and the other sheet ejection tray 31 can be used for ejecting the colorimetric printed material P2. When the color measurement is performed on the colorimetric printed material P2, the normal job can be resumed without removing the colorimetric printed material P2 after the color measurement, so that the productivity is improved. Further, it is also possible to take out the normal printed material P2 ejected to the first sheet ejection tray 311 during the color measurement on the colorimetric printed material P1 (including the standby for stabilizing the ink).

The conveyance section 40 conveys the recording material M sent from the sheet feed section 20 to the printing section 10, and also conveys the produced printed material P to eject it to the sheet ejection section 30. The conveyance section 40 includes, for example, a sheet feed path section 41, a first conveyance drum 42, a conveyance drum 43, a second conveyance drum 44, and a sheet ejection path section 45.

The sheet feed path section 41 conveys the recording material M sent out from the sheet feed section 20 to the first conveyance drum 42. In this embodiment, the sheet feed path section 41 includes a first sheet feed path section 411 for conveying the recording material M from the first sheet feed tray 211, and a second sheet feed path section 412 for conveying the recording material M from the second sheet feed tray 212.

The sheet feed path section 41 includes, for example, a plurality of support rollers and an endless belt wound around the support rollers (none of these constituent elements are illustrated). The recording material M sent out from the sheet feed tray 21 is conveyed to the first conveyance drum 42 by the endless belt which circularly travels by being driven by the rotation of the support rollers. The first conveyance drum 42 delivers the recording material M conveyed by the sheet feed path section 41 to the conveyance drum 43.

The conveyance drum 43 conveys the recording material M delivered from the sheet feed path section 41 along an outer circumferential surface that is a conveyance surface. For example, the conveyance drum 43 conveys the recording material M by rotating in a state in which the recording material M is adsorbed and held on the conveyance surface. While the recording material M is conveyed by the conveyance drum 43, printing is performed on the recording material M by the printing section 10, and the printed material P is produced. The produced printed material P is conveyed to the second conveyance drum 44 by the conveyance drum 43. The second conveyance drum 44 delivers the printed material P conveyed by the conveyance drum 43 to the sheet ejection path section 45.

The sheet ejection path section 45 conveys the printed material P delivered from the second conveyance drum 44 to the sheet ejection section 30. In the present embodiment, the sheet ejection path section 45 includes a first sheet ejection path section 451 for conveying the printed material P to the first sheet ejection tray 311 and a second sheet ejection path section 452 for conveying the printed material P to the second sheet ejection tray 312.

The sheet ejection path section 45 includes, for example, a plurality of support rollers and an endless belt wound around the support rollers (none of which are illustrated). The printed material P transferred from the second conveyance drum 44 is conveyed to the sheet ejection section 30 by the endless belt which is driven by the rotation of the support rollers and circulates.

The controller 50 is a hardware processor including a central processing unit (CPU) 51 serving as an arithmetic/control device, a read only memory (ROM) 52 serving as a main storage device, a random access memory (RAM) 53, and an auxiliary storage section 54. The ROM 52 stores therein a basic program and basic setting data.

The auxiliary storage section 54 is, for example, an auxiliary storage device such as a hard disk drive (HDD), a solid state drive (SSD), or a secure digital (SD) card . The auxiliary storage section 54 stores a program, various data, and the like.

For example, the CPU 51 reads a program corresponding to processing content from the ROM 52 or the auxiliary storage section 54, loads the program in the RAM 53, and executes the loaded program, thereby centrally controlling the operation of each block of the inkjet printing apparatus 1. The blocks of the inkjet printing apparatus 1 include a printing section 10, a sheet feed section 20, a sheet ejection section 30, a conveyance section 40, an operation part 61, a display part 62, a communication section 63, a colorimetric section 64, and a sensor section 65.

The controller 50 can execute normal print processing of producing the normal printed material P1 on the basis of a normal job, for example. For example, the controller 50 controls operations related to color measurement. The operations related to color measurement include production of the colorimetric printed material P2 based on the colorimetric job, color measurement on the colorimetric printed material P2, and color adjustment based on the color measurement result. Details of the colorimetric processing will be described later.

A part or all of the processes executed by the controller 50 may be executed by an electronic circuit such as a digital signal processor (DSP), an application specific integrated circuit (ASIC), or a programmable logic device (PLD) provided according to the processes.

The operation part 61 includes various operation keys such as a numeric keypad and a start key. The operation part 61 accepts various kinds of input operation by a user and outputs an operation signal to the controller 50. For example, the user can instruct execution, deletion, and change of the execution order of the print job, and cleaning (an example of maintenance) of the head unit 11 by operating the operation part 61.

The display part 62 includes, for example, a flat panel display such as a liquid crystal display and an organic EL display. According to a display control signal input from the controller 50, the display part 62 displays various operation screens, image states, individual function operation status, or the like.

Note that the operation part 61 and the display part 62 may be integrally formed by a flat panel display with a touch screen. Furthermore, the display part 62 may include a light emitting diode (LED), and the state of the inkjet printing apparatus 1 may be notified by turning on or blinking the LED.

The communication section 63 is, for example, a communication interface such as a network interface card (NIC), a MOdulator-DEModulator (MODEM), or a universal serial bus (USB). The communication section 63 may include a communication interface for short-range wireless communication such as Near Field Communication (NFC) or Bluetooth (registered trademark). The controller 50 transmits and receives various types of information to and from the terminal device 2 connected to the communication network 3 via the communication section 63.

The colorimetric section 64 performs, in-line, color measurement on the colorimetric printed material P2 ejected to the second sheet ejection tray 312. Color measurement (colorimetry) is to measure color information. The color information is, for example, color values such as L * a * b * values. The color measurer 64 is disposed above the second sheet ejection tray 312 so as to face the printed surface of the colorimetric printed material P2. The colorimetric section 64 outputs a color measurement result to the controller 50. The controller 50 makes a color adjustment as necessary on the basis of the color measurement result.

For example, a spectral colorimeter that performs color measurement by dispersing light reflected from the colorimetric printed material P2 can be applied to the colorimetric section 64. Furthermore, for example, the colorimetric section 64 may be configured to analyze an image captured by a camera or an image read by a scanner to calculate color information. In this case, the calculation of the color information may be performed by the controller 50.

The sensor section 65 includes various sensors capable of detecting the state of the inkjet printing apparatus 1. The various sensors include, for example, a recording material weight sensor, an ink remaining amount sensor, and a conveyance failure detection sensor. The recording material weight sensor detects the weight of the recording material M stored in the sheet feed tray 21. The remaining ink amount sensor detects a remaining amount of ink stored in an ink tank of the head unit 11. The conveyance failure detection sensor detects a conveyance failure (such as a paper jam) of the printed material P in the sheet ejection path section 45.

In the inkjet printing apparatus 1, various kinds of maintenance are performed. The various kinds of maintenance include, for example, replenishment of ink and cleaning of an ink ejection face in the printing section 10, replenishment/replacement of the recording material M in the sheet feed section 20, and resolution of a conveyance failure in the conveyance section 40.

During maintenance in which maintenance is performed, a print job is inexecutable. In the present embodiment, when various kinds of maintenance are performed in the inkjet printing apparatus 1, a colorimetric printed material is produced and color measurement is performed.

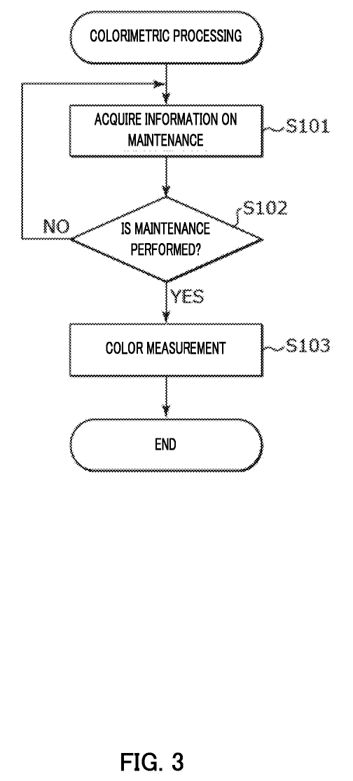

FIG. 3 is a flowchart showing an example of the colorimetric processing executed by the controller 50. This processing is implemented, for example, when the inkjet printing apparatus 1 is turned on and the CPU 51 executes a colorimetric processing program.

In step S101, the controller 50 acquires information on maintenance of the inkjet printing apparatus 1. The information related to maintenance includes, for example, the timing of automatic maintenance performed periodically and the output from the sensor section 65.

In step S102, the controller 50 determines, based on the information acquired in step S101, whether or not maintenance is to be performed. When the maintenance is performed ("YES" in step S102), the process proceeds to step S103. If maintenance is not to be performed ("NO" in step S102), the process proceeds to step S101.

In step S103, the controller 50 controls the printing section 10, the sheet feed section 20, the sheet ejection section 30, and the conveyance section 40 to produce the colorimetric printed material P2 based on the colorimetric job. Further, the controller 50 performs color measurement by the colorimetric section 64 and color adjustment based on the color measurement result.

Specifically, under the control of the controller 50, the sheet feed section 20 feeds the recording material M for color measurement. The recording material M for color measurement may be fed from the sheet feed tray 21 (for example, the first sheet feed tray 211) used for producing the normal printed material P1, or may be fed from another sheet feed tray 21 (for example, the second sheet feed tray 212). In a case where the sheet feed tray 21 used to produce the normal printed material P1 is empty of the recording material M and the recording material M is to be replenished in maintenance, the recording material M for color measurement is fed from another sheet feed tray 21.

The printing section 10 forms a colorimetric image (colorimetric chart) on the conveyed recording material M for color measurement to produce a colorimetric printed material P2. The colorimetric printed material P2 is ejected to the second sheet ejection tray 312.

After a predetermined time has elapsed since the colorimetric printed material P2 was ejected to the second sheet ejection tray 312 and the ink has become stable, the colorimetric section 64 performs color measurement on the colorimetric printed material P2. The color measurement result is output to the controller 50. The controller 50 makes a color adjustment as necessary on the basis of the color measurement result.

### Specific Example 1 of Maintenance

An example of maintenance performed in the inkjet printing apparatus 1 includes automatic maintenance that is periodically performed. The automatic maintenance is, for example, cleaning of the ink ejection faces of the head units 11. The automatic maintenance is automatically performed, for example, upon turning on the power of the inkjet printing apparatus 1, before execution of a normal job, upon lapse of a predetermined operating time, and upon reaching a predetermined number of printed sheets in operation.

In step S102 of FIG. 3, based on the timing at which the automatic maintenance is performed, the controller 50 determines whether or not the maintenance is to be performed. In step S103, the colorimetric printed material P2 is produced before the start of automatic maintenance, and color measurement is performed during automatic maintenance in which a print job is inexecutable. It is not necessary to interrupt a print job for the color measurement, and a standby time involved in the color measurement is significantly reduced.

### Specific Example 2 of Maintenance

As another example of the maintenance performed in the ink jet printing apparatus 1, there is an operation of replenishing an ink in the printing section 10 (head unit 11). The operation of replenishing an ink is manually performed by the user, for example, when an alert indicating that the remaining amount of ink is low is notified.

In step S102 of FIG. 3, the controller 50 determines, based on the output of the ink remaining amount sensor, whether or not the ink refilling operation is to be performed. In Step S103, the colorimetric printed material P2 is produced before the start of a replenishing operation of ink in which a print job is inexecutable, and color measurement is performed during the replenishing operation. It is not necessary to interrupt a print job for the color measurement, and a standby time involved in the color measurement is significantly reduced. Note that the colorimetric printed material P2 may be produced before the start of the ink replenishing operation or during the ink replenishing operation. In addition, it is assumed that the remaining amount of ink when the maintenance is performed is sufficient to the extent that the color quality of the colorimetric printed material P2 to be produced is not affected.

### Specific Example 3 of Maintenance

As another example of the maintenance performed in the ink jet printing apparatus 1, there is a replenishing operation of the recording material M in the sheet feed section 20. The operation of replenishing the recording material M is manually performed by the user, for example, when an alert indicating that the remaining amount of the recording material M is small is notified.

In step S102 of FIG. 3, the controller 50 determines, based on an output of the recording material remaining amount sensor, whether or not the operation of replenishing the recording material M is to be performed. In Step S103, the colorimetric printed material P2 is produced before the start of the operation of replenishing the recording materials M that cannot be subjected to the print job, and the color measurement is performed during the replenishing operation. It is not necessary to interrupt a print job for the color measurement, and a standby time involved in the color measurement is significantly reduced.

### Specific Example 4 of Maintenance

As another example of the maintenance performed in the ink jet printing apparatus 1, there is an operation of replacing the recording material M in the sheet feed section 20. The operation of replacing the recording material M is manually performed by a user, for example, when an alert instructing to replace the recording material M is notified. For example, when the recording material M specified in the print job is not stored in the sheet feed tray 21, an alert instructing to replace the recording material M is provided.

In step S102 of FIG. 3, the controller 50 determines whether or not the operation of replacing the recording material M is performed based on the information relating to the setting of the recording material M included in the print job and the information of the recording material M actually accommodated in the sheet feed tray 21. In Step S103, the colorimetric printed material P2 is produced before the start of the operation of replacing the recording materials M that cannot be subjected to the print job, and the color measurement is performed during the replacing operation. It is not necessary to interrupt a print job for the color measurement, and a standby time involved in the color measurement is significantly reduced.

### Specific Example 5 of Maintenance

As another example of the maintenance performed in the ink jet printing apparatus 1, there is an operation of eliminating a conveyance failure in the conveyance section 40. The elimination operation of the conveyance failure is manually performed by the user, for example, in a case where an alert indicating the occurrence of the conveyance failure is notified.

In step S102 of FIG. 3, the controller 50 determines whether or not the operation of eliminating the conveyance failure is performed based on the output of the conveyance failure detection sensor. In step S103, the colorimetric printed material P2 is produced before the start of the elimination operation of the conveyance failure in which the print job is inexecutable, and the color measurement is performed during the elimination operation. It is not necessary to interrupt a print job for the color measurement, and a standby time involved in the color measurement is significantly reduced.

When a conveyance failure occurs in the sheet feed path section 41 or the conveyance drum 43, the colorimetric printed material P2 cannot be produced, and therefore, color measurement cannot be performed during the operation of eliminating the conveyance failure. On the other hand, when a conveyance failure occurs in the first sheet ejection path section 451, the colorimetric printed material P2 can be produced and ejected to the second sheet ejection tray 312 via the second sheet ejection path section 452. That is, among the operations for eliminating the conveyance failure in the conveyance section 40, the operation for eliminating the conveyance failure in the first sheet ejection path section 451 is a target operation during which the color measurement can be performed.

As described above, the inkjet printing apparatus 1 according to the embodiment includes the following features alone or in appropriate combination.

That is, the inkjet printing apparatus 1 (printing apparatus) includes a sheet feed section 20 that feed a recording material M, a printing section 10 that forms an image based on a print job on the recording material M to produce a printed material P, a sheet ejection section 30 to which the printed material P is ejected, a conveyance section 40 that conveys the recording material M and the printed material P, and a controller 50 that controls operations related to color measurement. The controller 50 causes the colorimetric printed material P2 to be produced in a case where maintenance in which a print job is inexecutable is performed.

The colorimetric method according to the embodiment is a colorimetric method for the inkjet printing apparatus 1 that forms an image based on a print job on the recording material M to produce the printed material P, and includes determining whether maintenance in which the print job is inexecutable is to be performed (steps S101 to S102 in FIG. 3), and producing the printed material P2 for color measurement when the maintenance is performed (step S103).

Furthermore, the program according to the embodiment causes the controller 50 (computer) of the inkjet printing apparatus 1 that forms an image based on a print job on the recording material M to produce the printed material P to perform the processing of determining whether maintenance in which the print job is inexecutable is to be performed (steps S101 to S102 in FIG. 3), and the processing of producing the colorimetric printed material P2 when the maintenance is to be performed (step S103).

The program can be provided, for example, via a computer-readable portable storage medium in which the program is stored. The portable storage medium is, for example, a USB memory, a memory card, an external hard disk drive (HDD), an external solid state drive (SDD), an optical disk, or a magneto-optical disk. Furthermore, for example, the program can be provided by being downloaded from a server that holds the program via a network.

According to the inkjet printing apparatus 1, the colorimetric method, and the program according to the embodiment, it is possible to reduce the standby time associated with the color measurement by detecting in advance that the maintenance is performed, producing the colorimetric printed material P2 before the maintenance in which the print job is inexecutable is started, and performing the color measurement during the maintenance. Therefore, the time during which the print job is inexecutable is significantly shortened, and the productivity is improved.

In the ink jet printing apparatus 1, the maintenance includes automatic maintenance which is periodically performed, and the controller 50 determines whether or not the maintenance is performed based on a timing at which the automatic maintenance is performed. Specifically, the printing section 10 includes a head unit 11 capable of ejecting ink onto a recording material M, and the automatic maintenance includes cleaning of the ink ejection face in the printing section 10. In this way, it is possible to perform color measurement by using an automatic maintenance time such as cleaning of the ink ejection face.

In the inkjet printing apparatus 1, the printing section 10 includes a head unit 11 capable of ejecting ink onto a recording material M, the maintenance includes an operation of replenishing an ink in the printing section 10, and the controller 50 determines, based on the amount of ink remaining in the printing section 10, whether the maintenance is to be performed. Thus, the time required for the operation of replenishing an ink can be utilized to perform color measurement.

In the ink jet printing apparatus 1, the maintenance includes a replenishing operation of the recording material M in the sheet feed section 20, and the controller 50 determines whether or not the maintenance is performed based on the remaining amount of the recording material M in the sheet feed section 20. As a result, the color measurement can be carried out by utilizing the time required for the replenishing operation of the recording material M.

In the inkjet printing apparatus 1, the sheet feed section 20 includes the plurality of sheet feed trays 21 to store the recording material M, and when maintenance is performed, the controller 50 causes the recording material M to be fed from a sheet feed tray 21 that is not a maintenance target among the plurality of sheet feed trays 21, to produce the colorimetric printed material P2. As a result, even when the sheet feed tray 21 used for producing the normal printed material P1 becomes empty, the recording material M can be fed from another sheet feed tray 21 to produce the colorimetric printed material P2 and perform color measurement.

In the inkjet printing apparatus 1, the maintenance includes the operation of replacing the recording material M in the sheet feed section 20, and the controller 50 determines whether or not the maintenance is performed based on the setting of the recording material included in the print job. Thus, the time required for the operation of replacing the recording material M can be used to perform color measurement.

In the inkjet printing apparatus 1, the sheet ejection section 30 includes the first sheet ejection tray 311 and the second sheet ejection tray 312, and the controller 50 causes the normal printed material P1 produced on the basis of a normal job to be ejected to the first sheet ejection tray 311 and causes the colorimetric printed material P2 produced on the basis of a colorimetric print job to be ejected to the second sheet ejection tray 312. Thus, after the colorimetric printed material P2 is produced, the normal printed material P1 can be produced until maintenance is actually performed, thereby improving manufacturability.

In the inkjet printing apparatus 1, the maintenance includes an operation for eliminating a conveyance failure in the first sheet ejection path section 451 (the conveyance path to the first sheet ejection tray 311), and the controller 50 determines whether or not the maintenance is performed based on the conveyance status in the first sheet ejection path section 451. In this way, it is possible to perform the color measurement by using the time required for the operation of eliminating the conveyance failure in the first sheet ejection path section 451.

The inkjet printing apparatus 1 further includes the colorimetric section 64 disposed so as to be able to measure the color of the colorimetric printed material P2 ejected to the second sheet ejection tray 312. Thus, the color measurement on the colorimetric printed material P2 can be easily performed in-line.

Although the disclosure made by the present inventors has been specifically described above based on the embodiments, the present disclosure is not limited to the above-described embodiments and can be modified within the scope not departing from the spirit thereof.

The maintenance described in the embodiment is an example, and color measurement by the colorimetric section 64 may be performed when any other maintenance is performed. For example, in a case where the cleaning of the head unit 11 is manually instructed via the operation part 61, the colorimetric printed material P2 may be produced before the cleaning is performed, and the color measurement may be performed during the cleaning. For example, when replacement operation of the cleaning member or a tape inserter is performed, the color measurement may be performed during the replacement operation. Furthermore, for example, when the operation of taking out the printed material P in the sheet ejection section 30 is performed, the color measurement may be performed during the operation of taking out the printed material P.

In addition, the color measurement may not always be performed in a case where the maintenance is performed. For example, color measurement may be performed as necessary after a predetermined time elapses from the previous color measurement or after a predetermined number of sheets are printed.

Furthermore, the present disclosure may be applied to a multi-pass inkjet printing apparatus or a monochrome inkjet printing apparatus. The present disclosure is not limited to an inkjet printing apparatus, but may be applied to an electrophotographic printing apparatus.

In the embodiment, the colorimetric section 64 is incorporated in the inkjet printing apparatus 1, and the color measurement on the colorimetric printed material P2 is performed in-line, but the color measurement on the colorimetric printed material P2 may be performed off-line. That is, the printing apparatus according to the present disclosure may not include the colorimetric section 64.

Although embodiments of the present invention have been described and illustrated in detail, the disclosed embodiments are made for purpose of illustration and example only and not limitation. The scope of the present invention should be interpreted by terms of the appended claims.

What is claimed is:

1. A printing apparatus, comprising:
a sheet feeder that feeds a recording material;
a printer that forms an image based on a print job on the recording material to produce a printed material;
a sheet ejection section to which the printed material is ejected;
a conveyer that conveys the recording material and the printed material; and
a hardware processor that controls an operation related to color measurement, wherein
the hardware processor causes a colorimetric printed material to be produced in a case where maintenance in which the print job is inexecutable is performed.

2. The printing apparatus according to claim 1, wherein:
the maintenance includes automatic maintenance that is periodically performed, and
the hardware processor determines, based on a timing at which the automatic maintenance is performed, whether or not the maintenance is performed.

3. The printing apparatus according to claim 2, wherein:
the printer includes a head unit capable of ejecting ink onto the recording material, and
the automatic maintenance includes cleaning of an ink ejection face in the printer.

4. The printing apparatus according to claim 1, wherein:
the printer includes a head unit capable of ejecting ink onto the recording material,
the maintenance includes an operation of replenishing an ink in the printer, and
the hardware processor determines, based on a remaining amount of ink in the printer, whether or not the maintenance is to be performed.

5. The printing apparatus according to claim 1, wherein:
the maintenance includes an operation of replenishing the recording material in the sheet feeder, and
the hardware processor determines, based on a remaining amount of the recording material in the sheet feeder, whether or not the maintenance is to be performed.

6. The printing apparatus according to claim 5, wherein:
the sheet feeder includes a plurality of sheet feed trays that accommodate the recording material, and
when the maintenance is performed, the hardware processor causes the recording material to be fed from a sheet feed tray among the plurality of sheet feed trays which is not a target of the maintenance, and causes the colorimetric printed material to be produced.

7. The printing apparatus according to claim 1, wherein:
the maintenance includes an operation of replacing the recording material in the sheet feeder, and
the hardware processor determines, based on recording material information included in the print job, whether or not the maintenance is to be performed.

8. The printing apparatus according to claim 1, wherein:
the sheet ejection section includes a first sheet ejection tray and a second sheet ejection tray, and
the hardware processor causes a normal printed material produced based on a normal print job to be ejected to the first sheet ejection tray, and causes the colorimetric printed material produced based on the print job for color measurement to be ejected to the second sheet ejection tray.

9. The printing apparatus according to claim 8, wherein:
the maintenance includes an operation of eliminating a conveyance failure in a conveyance path to the first sheet ejection tray, and
the hardware processor determines, based on a conveyance status in the conveyance path, whether or not the maintenance is to be performed.

10. The printing apparatus according to claim 8, further comprising:
a colorimeter disposed to be capable of performing color measurement on the colorimetric printed material ejected to the second sheet ejection tray.

11. A colorimetric method for a printing apparatus that forms an image based on a print job on a recording material to produce a printed material, the colorimetric method comprising:
determining whether or not maintenance in which the print job is inexecutable is performed; and
producing a colorimetric printed material when the maintenance is performed.

12. A non-transitory computer-readable recording medium storing a program that causes a computer of a printing apparatus to perform predetermined processing, the printing apparatus being configured to form an image on a recording material based on a print job to produce a printed material, wherein
the predetermined processing includes:
processing of determining whether or not maintenance in which the print job is inexecutable is performed; and
processing of producing a colorimetric printed material when the maintenance is performed.
